(19) United States
(12) Patent Application Publication
(10) Pub. No.: US 2025/0132470 A1
(43) Pub. Date: Apr. 24, 2025

(54) CURRENT COLLECTOR BRACKET ASSEMBLY FOR A PRISMATIC BATTERY

(71) Applicant: GM Global Technology Operations LLC, Detroit, MI (US)

(72) Inventors: Stephanie Girges, Windsor (CA); Wai Ping Gloria Tam, Troy, MI (US); David F. Titmuss, Commerce Township, MI (US); Daniel Gerardo Gonzalez, Lake Orion, MI (US); Christopher D. James Megdanoff, Fenton, MI (US); Teresa J. Rinker, Royal Oak, MI (US); Jared Matthew Satkowiak, Grand Blanc, MI (US); Raghavendra Keerthi Manda, Northville, MI (US)

(21) Appl. No.: 18/490,179

(22) Filed: Oct. 19, 2023

(51) Int. Cl. H01M 50/54; H01M 4/66; H01M 50/533; H01M 50/534; H01M 50/536

(52) U.S. Cl. CPC H01M 50/54; H01M 4/661; H01M 50/533; H01M 50/534; H01M 50/536; H01M 2220/20

(57) ABSTRACT

A battery cell stack assembly for a prismatic battery includes a plurality of monocells and two current collector bracket assemblies. Each monocell includes an anode electrode sheet having an outer perimeter and an anode cell tab and a cathode electrode sheet having a cathode cell tab. One of the current collector bracket assemblies electrically connect each of the anode cell tabs with one another and a remaining current collector bracket assembly electrically connects each of the cathode cell tabs with one another, and each current collect bracket assembly includes at least one arm that is positioned to electrically connect either two or more of the anode cell tabs or two or more of the cathode cell tabs to one another.

### INTRODUCTION

The present disclosure relates to a current collector bracket assembly for a prismatic battery.

One type of energy storage system is a prismatic battery that includes a plurality of battery cells arranged in a stacked configuration, where the battery cells are electrically connected to one another. Each cell of a prismatic battery includes an anode, a cathode, and a separator. The anode includes a negative current collector that is a foil sheet constructed of a conductive material such as copper, while the cathode includes a positive current collector constructed of another conductive material such as aluminum. The foil sheets of the anode and the cathode of each cell in a prismatic battery are provided with a respective foil tab. The foil tab may also be referred to as an electrode cell tab.

During an assembly process, the respective anodes of each cell of the prismatic battery are electrically connected to one another, while a similar operation is performed for the respective cathodes of each cell of the prismatic battery as well. Specifically, the foil tabs of each anode are electrically connected to one another by bending the respective foil tabs to contact one another, where the foil tabs are joined to a current collector. A similar approach is employed to electrically connect the cathodes to one another as well. It is to be appreciated that a prismatic battery usually includes numerous cells that are joined together. As a result, the respective foil tabs of some of the anodes or cathodes may be bent at relatively sharp angles up to about ninety degrees to contact one another. Bending the foil tabs at sharp angles introduces stress and strain to the foil sheets. As a result, in some instances, the foil sheet of the anodes and cathodes may tear as the foil tabs are bent.

Thus, while current batteries achieve their intended purpose, there is a need in the art for an improved approach for electrically connecting two or more cells to one another.

### SUMMARY

According to several aspects, a battery cell stack assembly for a prismatic battery is disclosed and includes a plurality of monocells. Each monocell includes an anode electrode sheet having an outer perimeter and an anode cell tab projecting outward from and extends past the outer perimeter of the anode electrode sheet and a cathode electrode sheet having an outer perimeter and a cathode cell tab projecting outward from and extends past the outer perimeter of the cathode electrode sheet. Each of the anode cell tabs of the battery cell stack assembly are aligned with one another and each of the cathode cell tabs are aligned with one other. The battery cell stack assembly also includes at least one current collector bracket assembly. The at least one current collector bracket assembly electrically connects either each of the anode cell tabs with one another or each of the cathode cell tabs with one another. The at least one current collect bracket assembly includes at least one arm that is positioned to electrically connect either two or more of the anode cell tabs or two or more of the cathode cell tabs to one another.

In another aspect, the at least one arm of the at least one current collector bracket assembly defines opposing surfaces. Both opposing surfaces of each arm are in electrical contact with either one or more of the anode cell tabs or one or more of the cathode cell tabs.

In yet another aspect, the at least one arm of the at least one current collector bracket assembly defines opposing surfaces, and wherein a single surface of each arm is in electrical contact with either one or more of the anode cell tabs or one or more of the cathode cell tabs.

In an aspect, the at least one current collector bracket assembly includes a plurality of arms.

In another aspect, each arm of the plurality of arms of the at least one current collector bracket assembly defines a proximate end, a distal end, an angled portion, and a linear portion.

In yet another aspect, the proximate end of each arm of the at least one current collector bracket assembly defines an opening, and wherein the proximate end of each of the plurality of arms of the at least one current collector bracket assembly are stacked one on top of another to align the respective openings of each of the plurality of arms with one another.

In an aspect, a mechanical fastener is received by each of the openings of the plurality of arms.

In another aspect, the mechanical fastener is a blind rivet.

In yet another aspect, the angled portion of each arm of the at least one current collector bracket assembly is shaped to direct the arm from the proximate end positioned to either the anode cell tabs or the cathode cell tabs.

In an aspect, the linear portion of each arm of the at least one current collector bracket assembly is in electrical contact with either the anode cell tabs or the cathode cell tabs.

In another aspect, the anode electrode sheet is constructed at least in part by copper.

In yet another aspect, the at least one current collector bracket assembly that electrically connects the anode cell tabs with one another is constructed at least in part of copper or a copper alloy.

In an aspect, the cathode electrode sheet is constructed at least in part by aluminum.

In another aspect, the at least one current collector bracket assembly that electrically connects the anode cell tabs with one another is constructed at least in part of aluminum or an aluminum alloy.

In yet another aspect, up to about one hundred and twenty electrode cell tabs are joined to the at least one arm.

In an aspect, a method of assembling a plurality of cell stacks together to create a battery cell stack assembly is disclosed. The method includes aligning a plurality of anode cell tabs and a plurality of cathode cell tabs of a cell stack with one another, where the cell stack includes two or more monocells that each include an anode electrode sheet having an outer perimeter and an anode cell tab projecting outward from and extends past the outer perimeter of the anode electrode sheet and a cathode electrode sheet having an outer perimeter and a cathode cell tab projecting outward from and extends past the outer perimeter of the cathode electrode sheet. The method also includes electrically connecting the plurality of anode cell tabs with an arm that is part of one of two current collector bracket assemblies by a joining process and electrically connecting the plurality of cathode cell tabs with the arm of a remaining one of the two current collector bracket assemblies by the joining process, where each current collector bracket assembly includes a plurality of arms. The method includes aligning an opening defined by a proximate end of each of the plurality of arms of a respective current collector bracket assembly with one another. Finally, the method includes securing the plurality of arms of each current collector bracket assembly to one another by a mechanical fastener received by the openings defined by the proximate end of each of the plurality of arms. Each arm of each current collector bracket is electrically connected to one of the plurality of cell stacks.

In another aspect, the method includes electrically connecting the plurality of anode cell tabs with the arm that is part of one of the two current collector bracket assemblies and electrically connecting the plurality of cathode cell tabs with the arm of the remaining one of the two current collector bracket assemblies by ultrasonic welding.

In yet another aspect, a battery cell stack assembly for a prismatic battery is disclosed and includes a plurality of monocells. Each monocell includes an anode electrode sheet having an outer perimeter and an anode cell tab projecting outward from and extends past the outer perimeter of the anode electrode sheet and a cathode electrode sheet having an outer perimeter and a cathode cell tab projecting outward from and extends past the outer perimeter of the cathode electrode sheet. Each of the anode cell tabs of the battery cell stack assembly are aligned with one another and each of the cathode cell tabs are aligned with one other. The battery cell stack also includes two current collector bracket assemblies, where one of the current collector bracket assemblies electrically connect each of the anode cell tabs with one another and a remaining current collector bracket assembly electrically connects each of the cathode cell tabs with one another. Each current collect bracket assembly includes a plurality of arms that are each positioned to electrically connect either two or more of the anode cell tabs or two or more of the cathode cell tabs to one another, and each arm of the plurality of arms of each current collector bracket assembly defines a proximate end, a distal end, an angled portion, and a linear portion.

In another aspect, the proximate end of each arm of the current collector bracket assembly defines an opening, where the proximate end of each of the plurality of arms of the current collector bracket assembly are stacked one on top of another to align the respective openings of each of the plurality of arms with one another.

In yet another aspect, a mechanical fastener is received by each of the openings of the plurality of arms.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 illustrates a vehicle including a battery pack having a plurality of battery modules and battery cells, according to an exemplary embodiment;

FIG. 2 is perspective view of a battery cell stack assembly including a plurality of battery cell stacks and two current collector bracket assemblies, according to an exemplary embodiment;

FIG. 3 is a disassembled view of one of a monocell that is part of the battery cell stack assembly shown in FIG. 2, according to an exemplary embodiment;

FIG. 4 is perspective view of an alternative embodiment of the battery cell stack assembly shown in FIG. 2, according to an exemplary embodiment;

FIG. 5 is a perspective view of the current collector bracket assembly, according to an exemplary embodiment;

FIG. 6A illustrates two or more anode cell tabs and cathode cell tabs before being joined to an arm of the current collector bracket assembly, according to an exemplary embodiment;

FIG. 6B illustrates the two or more anode cell tabs and cathode cell tabs in FIG. 6A after being joined to the arm of the current collector bracket assembly, according to an exemplary embodiment; and

FIG. 7 illustrates a process flow diagram illustrating a method for assembling the battery cell stack assembly shown in FIG. 2, according to an exemplary embodiment.

### DETAILED DESCRIPTION

The following description is merely exemplary in nature and is not intended to limit the present disclosure, application, or uses.

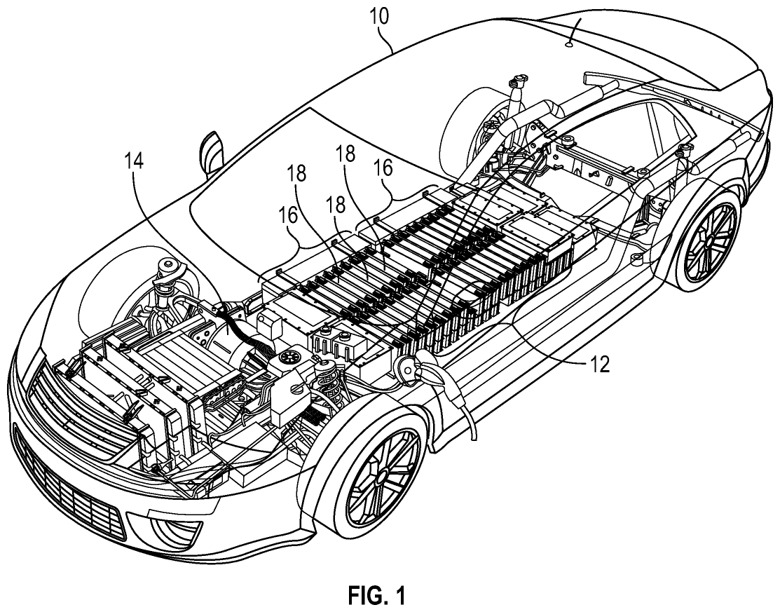

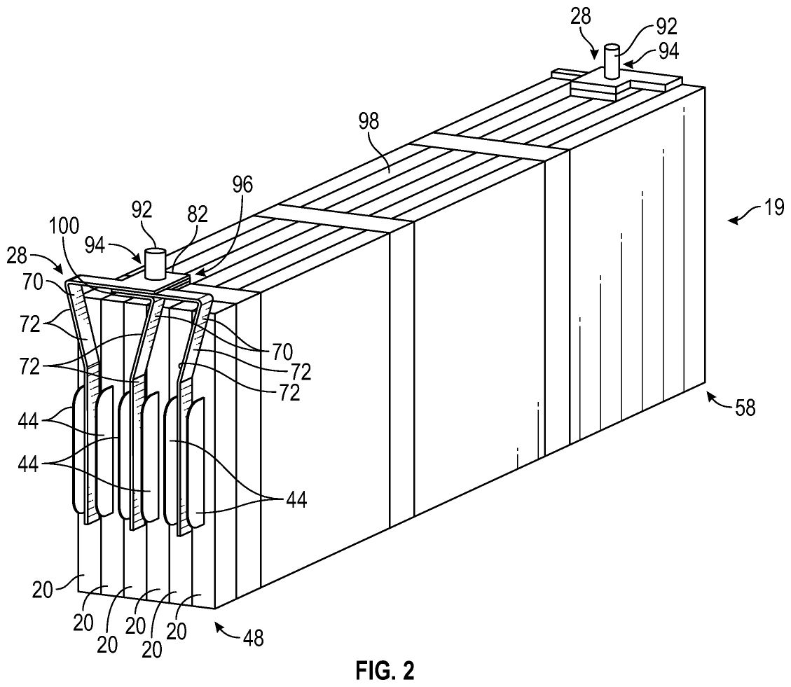

Referring to FIG. 1, a vehicle 10 including an exemplary battery pack 12 for providing power to an electric motor 14 is illustrated. The battery pack 12 includes a plurality of battery modules 16 that are electrically connected to one another. Each battery module 16 includes a housing 18 that encloses a battery cell stack assembly 19 including a plurality of monocells 20 (seen in FIG. 2). Although FIG. 1 illustrates the battery pack 12 as a secondary battery for providing power to the electric motor 14 of a vehicle 10, it is to be appreciated that FIG. 1 is merely exemplary in nature, and the plurality of battery modules 16 are not limited to being employed as a secondary battery for a vehicle. Indeed, the battery modules 16 may be used in a variety of other electromobility and stationary applications. It is also to be appreciated that although the vehicle 10 is illustrated as a sedan, the vehicle 10 may be any type of vehicle such as, but not limited to, a truck, sport utility vehicle, van, or motor home.

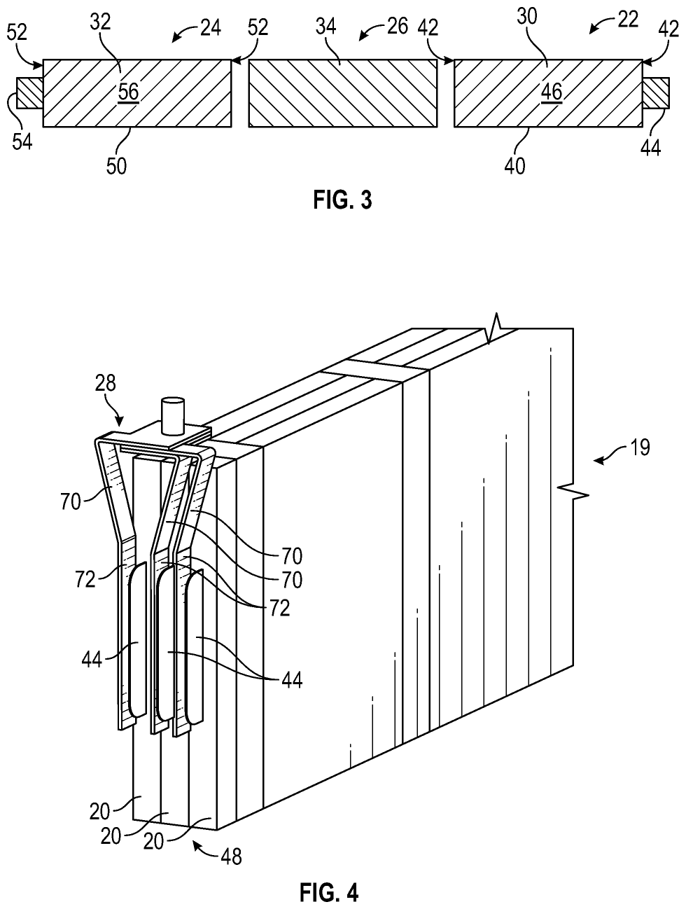

FIG. 2 is a perspective view of the battery cell stack assembly 19 including the plurality of monocells 20 that are enclosed within the housing 18 of one of the battery modules 16 shown in FIG. 1. FIG. 3 is an assembly view of a single monocell 20 that is part of the battery cell stack assembly 19 shown in shown in FIG. 2. It is to be appreciated that only six monocells 20 are illustrated in FIG. 2 as part of the battery cell stack assembly 19 for purposes of simplicity and clarity. Referring to both FIGS. 2 and 3, the battery cell stack assembly 19 includes the plurality of monocells 20 and at least one current collector bracket assembly 28. Each monocell 20 includes an anode 22, a cathode 24, a separator 26. As explained below, one of the current collector bracket assemblies 28 electrically connect the anode 22 of each monocell 20 of the battery cell stack assembly 19 to one another, and the remaining current collector bracket assembly 28 electrically connects the cathode 24 of each monocell 20 of the battery cell stack assembly 19 to one another. Although two current collector bracket assemblies 28 are described, it is to be appreciated that the battery cell stack assembly 19 may include only one current collector bracket assembly 28 to connect the anode 22 of each monocell 20 of the battery cell stack assembly 19 together or, alternatively, the battery cell stack assembly 19 may include only one current collector bracket assembly 28 to connect the cathode 24 of each monocell 20 of the battery cell stack assembly 19 together. It is to be appreciated that the current collector bracket assemblies 28 may be used in any type of prismatic battery where the individual monocells 20 are positioned relative to one another in a stacked configuration.

Referring specifically to FIG. 3, the anode 22 includes an anode electrode sheet 30 constructed at least in part of a conductive material such as, but not limited to, copper or a copper alloy. Similarly, the cathode includes a cathode electrode sheet 32 constructed at least in part of a conductive material such as, but not limited to, aluminum or an aluminum alloy. The separator 26 is positioned between the anode 22 and the cathode 24 and includes a separator sheet 34 constructed of an electrically insulative material. The anode electrode sheet 30, the cathode electrode sheet 32, and the separator sheet 34 each include a substantially flat, planar profile. In the embodiment as illustrated, the anode electrode sheet 30, the cathode electrode sheet 32, and the separator sheet 34 are each planar sheets having a rectangular profile; however, it is to be appreciated that the anode electrode sheet 30, the cathode electrode sheet 32, and the separator 26 are not limited to a rectangular profile and may include other shapes as well.

Referring specifically to FIG. 3, the anode electrode sheet 30 of each monocell 20 includes an outer perimeter 40 defining opposing sides 42, where one of the opposing sides 42 of the anode electrode sheet 30 includes an anode cell tab 44 that projects outward and extends past the outer perimeter 40 of the anode electrode sheet 30. The anode electrode sheet 30 is coated with an anode active coating 46, however, the anode cell tab 44 remains uncoated. Referring specifically to FIG. 2, the anode cell tabs 44 project outward and extend past a first side 48 of the battery cell stack assembly 19. The monocells 20 are arranged within the battery cell stack assembly 19 to align each of the anode cell tabs 44 with one another. That is, the anode cell tabs 44 of each monocell 20 that is part of the battery cell stack assembly 19 are oriented on one side 48 of the battery cell stack assembly 19 and are aligned with one another.

Similarly, as seen in FIG. 3, the cathode electrode sheet 32 of each monocell 20 includes an outer perimeter 50 defining opposing sides 52, where one of the opposing sides 52 of the cathode electrode sheet 32 includes a cathode cell tab 54 that projects outward and extends past the outer perimeter 50 of the cathode electrode sheet 32. The cathode electrode sheet 32 is coated with a cathode active coating 56, however, the cathode cell tab 54 remains uncoated. Referring to FIG. 2, it is to be appreciated that an opposing side 58 of the battery cell stack assembly 19 where the cathode cell tabs 54 are located is not visible. However, it is to be appreciated that the cathode cell tabs 54 project outward and extend past a second side 58 of the battery cell stack assembly 19, where the second side 58 opposes the first side 48 of the battery cell stack assembly 19. Referring to FIGS. 2 and 3, the monocells 20 are arranged within the battery cell stack assembly 19 to align each of the cathode cell tabs 54 (shown in FIG. 3) with one another in an arrangement similar to the anode cell tabs 44.

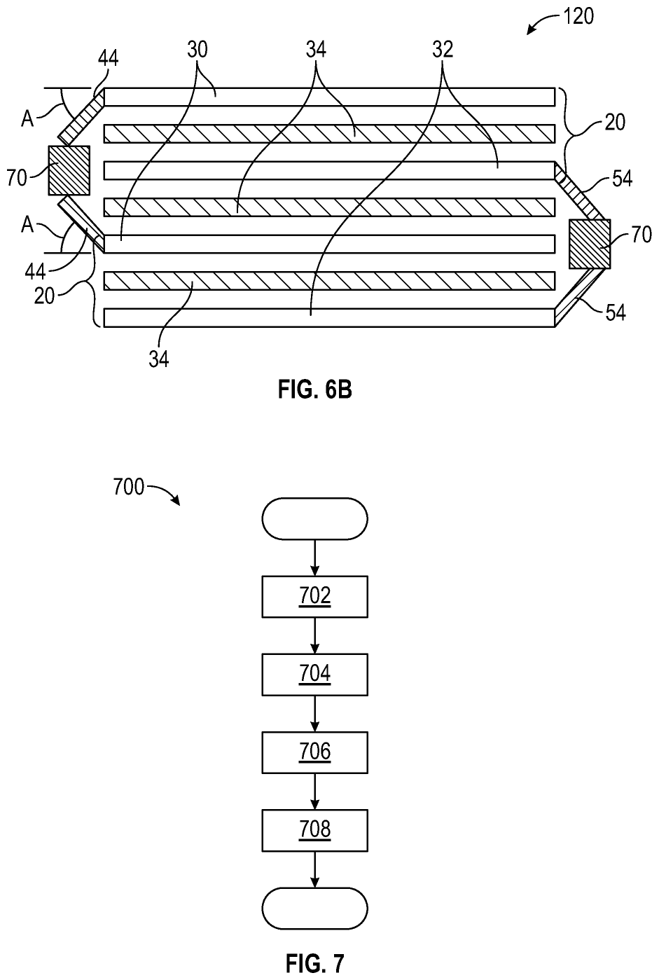

Referring to FIG. 2, one of the current collector bracket assemblies 28 electrically connect the anode cell tabs 44 with one another and a remaining current collector bracket assembly 28 electrically connects the cathode cell tabs 54 (FIG. 3) with one another. Each current collect bracket assembly 28 includes at least one arm 70 that electrically connects at least two of the anode cell tabs 44 or at least two of the cathode cell tabs 54 to one another, depending on which side 48, 58 of the battery cell stack assembly 19 the current collector bracket assembly 28 is located. In the embodiment as shown in FIG. 2, each current collector bracket assembly 28 includes a plurality of arms 70 that each electrically connect two of the anode cell tabs 44 to one another, however, it is to be appreciated that only two anode cell tabs 44 are shown for purposes of simplicity and clarity. Indeed, each arm 70 of the current collector bracket assembly 28 may electrically connect as few as two or as many as one hundred and twenty electrode cell tabs 44, 54 to one another. It is to be appreciated that the maximum number of one hundred and twenty electrode cell tabs 44, 54 may vary based on the thickness of the electrode cell tabs 44, 54, the thickness of the current collector bracket assembly 28, and the capabilities of the joining process described below that electrically connects the arms 70 to the electrode cell tabs 44, 54, which is illustrated in FIG. 6A.

It is to be appreciated that FIGS. 2 and 4 illustrate the current collector bracket assemblies 28 before electrically connecting the arms 70 to either the anode cell tabs 44 or the cathode cell tabs 54 by a joining process such as, for example, ultrasonic welding. The joining process is described below and an illustration of the electrical contact between the arms 70 of the current collector bracket assembly 28 and the either the anode cell tabs 44 or the cathode cell tabs 54 is illustrated in FIG. 6B and is described below.

Referring to FIG. 2, in an embodiment the current collector bracket assembly 28 is constructed at least in part of the same conductive material as the respective cell tab 44, 54 the arms 70 (the cathode cell tabs 54 are visible in FIG. 3) are electrically connected to. Specifically, in one embodiment, the current collector bracket assembly 28 that electrically connects the anode cell tabs 44 together is constructed at least in part of copper or a copper alloy, and the remaining current collector bracket assembly 28 that connects the cathode cell tabs 54 together is constructed at least in part of aluminum or an aluminum alloy.

Each arm 70 of the current collector bracket assembly 28 defines opposing surfaces 72. In the embodiment as shown in FIG. 2, both opposing surfaces 72 of the arms 70 are in electrical contact with one or more of the anode cell tabs 44 and the three arms 70 of the current collector bracket assembly 28. However, FIG. 4 is an alternative embodiment of the battery cell stack assembly 19 where only a single surface 72 of each arm 70 of the current collector bracket assembly 28 is in electrical contact with the anode cell tabs 44. It is to be appreciated that while the anode cell tabs 44 are discussed and are visible in FIG. 2, the remaining side 58 of the battery cell stack assembly 19 including the cathode cell tabs 54 includes a similar arrangement as well.

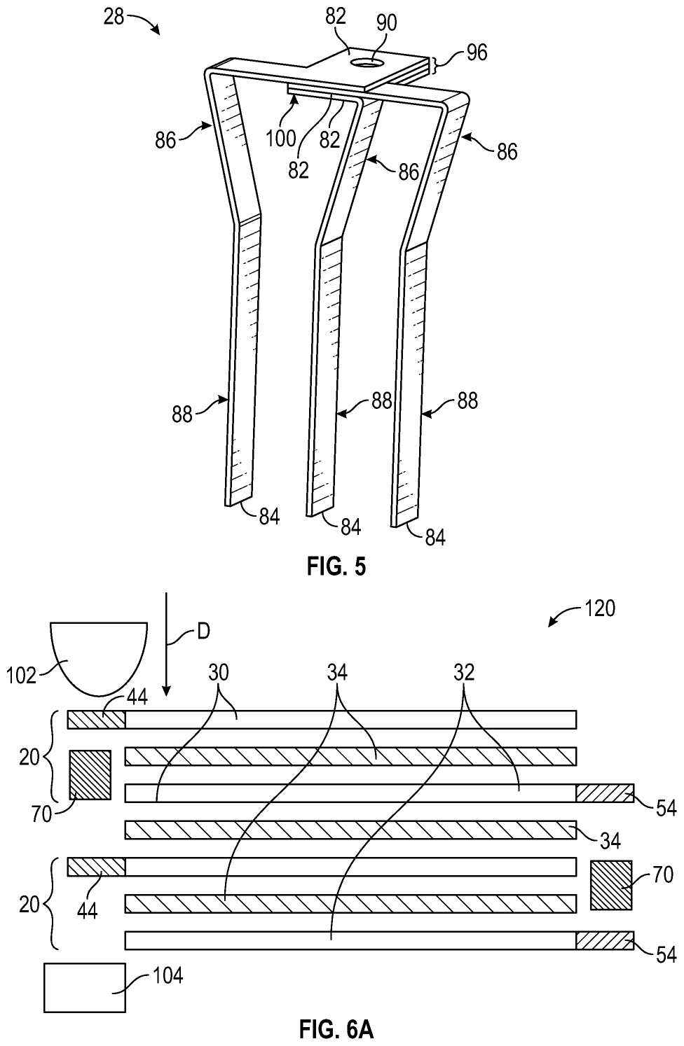

FIG. 5 is a perspective view of the current collector bracket assembly 28 shown in FIG. 2. Referring to FIG. 5, each arm 70 of the current collector bracket assembly 28 defines a proximate end 82, a distal end 84, an angled portion 86, and a linear portion 88. The proximate end 82 of each arm 70 of each current collector bracket assembly 28 defines an opening 90 shaped to receive a shank 92 of a mechanical fastener 94 (seen in FIG. 2). The mechanical fastener 94 secures each of the arms 70 of the current collector bracket assembly 28 to one another. In the non-limiting embodiment as shown in FIG. 2, the mechanical fastener 94 is a blind rivet, which includes an unthreaded shank 92 that is received by each of the openings 90 of the arms 70. It is to be appreciated that the blind rivet is secured to a proximate end 82 of an arm 70 of the current collector bracket assembly 28 located at the bottom 100 of a stack 96 of arms 70 (shown in FIG. 5) by a joining process such as laser welding. Although a blind rivet is described, it is to be appreciated that the mechanical fastener 94 may also include other fastening devices as well.

Referring to both FIGS. 2 and 5, the proximate end 82 of each of the plurality of arms 70 of the current collector bracket assembly 28 are stacked one on top of another and the respective openings 90 of each of the plurality of arms 70 are aligned with one another to create the stack 96 of proximate ends 82. The stack 96 is positioned on an upper or top side 98 of the battery cell stack assembly 19. The shank 92 of the mechanical fastener 94 is received by each of the openings 90 located in the stack 96 of proximate ends 82 of each of the arms 70 that are part of the current collector bracket assembly 28. In the event a blind rivet is used as the mechanical fastener 94, the proximate end 82 of the arm 70 located at the bottom 100 of the stack 96 is welded to the blind rivet.

The proximate end 82 is connected to the angled portion 86 of each arm 70. The angled portion 86 of each arm 70 of the current collector bracket assembly 28 is shaped to direct the arm 70 from the proximate end 82 positioned at the top side 98 of the battery cell stack assembly 19 to either the anode cell tabs 44 or the cathode cell tabs 54, depending upon which side 48, 58 of the battery cell stack assembly 19 the respective current collector bracket assembly 28 is located. Each angled portion 86 of the arm 70 of the current collector bracket assembly 28 includes a unique profile, since each arm 70 follows a unique path from the top side 98 of the battery cell stack assembly 19 towards either the anode cell tabs 44 or the cathode cell tabs 54. The linear portion 88 is connected to the angled portion 86 and the distal end 84 of each arm 70. The linear portion 88 of the arm 70 of the current collector bracket assembly 28 includes a linear or straight profile and is positioned to align with either the anode cell tabs 44 or the cathode cell tabs 54. The linear portion 88 of each arm 70 is in electrical contact with either the anode cell tabs 44 or the cathode cell tabs 54.

FIG. 6A is a top view of an exemplary illustration of the anode cell tabs 44 and the cathode cell tabs 54 of a cell stack 120 before the corresponding arm 70 of the current collector bracket assembly 28 is electrically connected to the anode cell tabs 44, and FIG. 6B illustrates the anode cell tabs 44 after being electrically connected to the arm 70. In the example as shown in FIGS. 6A and 6B, only two anode cell tabs 44 and two cathode cell tabs 54 are illustrated being electrically connected to the corresponding arm 70 for purposes for clarity and ease of illustration, however, it is to be appreciated that up to about one hundred and twenty electrode cell tabs 54 may be electrically connected to the arm 70 at a time.

The cell stack 120 includes two or more monocells 20, where the anode cell tabs 44 are each electrically connected to one another by an arm 70 of one of the current collector bracket assemblies 28 and the cathode cell tabs 54 are each electrically connected to one another by the arm 70 of the remaining current collector bracket assembly 28 of the battery cell stack assembly 19. That is, each cell stack 120 corresponds to one of the arms 70 of the current collector bracket assembly 28 that electrically connects the anodes 22 together and one of the arms 70 of the current collector bracket assembly 28 that electrically connects the cathodes 24 together. The battery cell stack assembly 19 shown in FIG. 2 is comprised of two or more cell stacks 120. A method 700 assembling the cell stacks 120 to create the battery cell stack assembly 19 is illustrated in FIG. 7 and is described in greater detail below.

In the non-limiting embodiment as shown in FIG. 6A, the anode cell tabs 44 are joined to the arm 70 by ultrasonic welding employing a horn 102 and an anvil 104, where the horn 102 moves in the direction D towards the anode cell tabs 44 and acts as a resonator, while the anvil 104 remains stationary and acts as a support jig. A similar approach is utilized to join the cathode cell tabs 44 to a corresponding arm 70 as well. Although FIG. 6A illustrates the anode cell tabs 44 an cathode cell tabs 54 joined to the arm 70 by ultrasonic welding, it is to be appreciated that other joining processes may be used as well such as, but not limited to, one-sided laser welding and resistance spot welding.

Referring now to FIG. 6B, the anode cell tabs 44 and the cathode cell tabs 54 are bent or deformed in a direction towards the arm 70 of the respective current collector bracket assembly 28 during the joining process at an angle A to establish electrical contact between the anode cell tabs 44 and the respective arm 70. In one embodiment, the angle A of the anode cell tabs 44 is less than about thirty-five degrees (35°). In contrast, current techniques that are presently employed to electrically connect the anode cell tabs 44 or the cathode cell tabs 54 to one another may require bending up to ninety degrees.

Referring generally to FIGS. 2 and 6A-6B, although the current collector bracket assemblies 28 shown in the figures illustrate three arms 70, the figures are merely exemplary in nature and the current collector bracket assemblies 28 may include any number of arms 70 required to electrically connect either all the anode cell tabs 44 or all the cathode cell tabs 54 to one another. It is to be appreciated that the number of anode cell tabs 44 or cathode cell tabs 54 that may be electrically connected to one another at a time are limited by the joining process employed (e.g., ultrasonic welding). Therefore, the number of arms 70 as well as the geometry of each arm 70 of the current collector bracket assembly 28 may be specifically tailored to accommodate the limitations of the joining process. The arms 70 may also be specifically tailored to accommodate factors such as, but not limited to, the length of the battery cell stack assembly, rivet size, and battery electrical capacity.

FIG. 7 is a process flow diagram illustrating an exemplary method 700 for assembling two or more cell stacks 120 together to create the battery cell stack assembly 19 shown in FIG. 2. Referring generally to FIGS. 2-7, the method 700 may begin at block 702. In block 702, the plurality of anode cell tabs 44 and the plurality of cathode cell tabs 54 of a cell stack 120 (shown in FIG. 6A) are aligned with one another before a joining process. The method 700 may then proceed to block 704.

In block 704, the plurality of anode cell tabs 44 are electrically connected with an arm 70 that is part of one of two current collector bracket assemblies 28 by a joining process, and the plurality of cathode cell tabs 54 are electrically connected with the arm of a remaining one of the two current collector bracket assemblies 28 by the joining process, which is shown in FIGS. 6A and 6B. In one embodiment the joining process is ultrasonic welding. The method 700 may then proceed to block 706.

In block 706, the opening 90 defined by the proximate end 82 of each of the plurality of arms 70 of a respective current collector bracket assembly 28 (seen in FIG. 5) are aligned with one another. The method 700 may then proceed to block 708.

In block 708, the plurality of arms 70 of each current collector bracket assembly 28 are secured to one another by a mechanical fastener 94 (seen in FIG. 2). The mechanical fastener 94 received by the openings 90 defined by the proximate end 82 of each of the plurality of arms 70. It is to be appreciated that each arm 70 of each current collector bracket assembly 28 is electrically connected to one of the plurality of cell stacks 120 (shown in FIGS. 6A and 6B). The method 700 may then terminate.

Referring generally to the figures, the disclosed current collector bracket assembly provides various technical effects and benefits. Specifically, the anode and cathode cell tabs of the monocells that are electrically connected by the disclosed current collector bracket assembly undergo less bending or deformation when compared to current techniques that are presently employed to electrically connect the anode cell tabs or the cathode cell tabs to one another. Reducing the amount of bending required reduces the stress and strain introduced to the foil sheets of the electrodes. Moreover, the number of arms included by the current collector bracket assembly as well as the geometry of the arms may be specifically tailored to accommodate the limitations of the joining process employed to electrically connect the anode and cathode cell tabs together, as well as factors such as the length of the battery cell stack and rivet size.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A battery cell stack assembly for a prismatic battery, the battery cell stack assembly comprising:
a plurality of monocells, wherein each monocell comprises:
an anode electrode sheet having an outer perimeter and an anode cell tab projecting outward from and extends past the outer perimeter of the anode electrode sheet and a cathode electrode sheet having an outer perimeter and a cathode cell tab projecting outward from and extends past the outer perimeter of the cathode electrode sheet, wherein each of the anode cell tabs of the battery cell stack assembly are aligned with one another and each of the cathode cell tabs are aligned with one other; and
at least one current collector bracket assembly, wherein the at least one current collector bracket assembly electrically connects either each of the anode cell tabs with one another or each of the cathode cell tabs with one another, and wherein the at least one current collect bracket assembly includes at least one arm that is positioned to electrically connect either two or more of the anode cell tabs or two or more of the cathode cell tabs to one another.

2. The battery cell stack assembly of claim 1, wherein the at least one arm of the at least one current collector bracket assembly defines opposing surfaces, and wherein both opposing surfaces of each arm are in electrical contact with either one or more of the anode cell tabs or one or more of the cathode cell tabs.

3. The battery cell stack assembly of claim 1, wherein the at least one arm of the at least one current collector bracket assembly defines opposing surfaces, and wherein a single surface of each arm is in electrical contact with either one or more of the anode cell tabs or one or more of the cathode cell tabs.

4. The battery cell stack assembly of claim 1, wherein the at least one current collector bracket assembly includes a plurality of arms.

5. The battery cell stack assembly of claim 4, wherein each arm of the plurality of arms of the at least one current collector bracket assembly defines a proximate end, a distal end, an angled portion, and a linear portion.

6. The battery cell stack assembly of claim 5, wherein the proximate end of each arm of the at least one current collector bracket assembly defines an opening, and wherein the proximate end of each of the plurality of arms of the at least one current collector bracket assembly are stacked one on top of another to align the respective openings of each of the plurality of arms with one another.

7. The battery cell stack assembly of claim 6, wherein a mechanical fastener is received by each of the openings of the plurality of arms.

8. The battery cell stack assembly of claim 7, wherein the mechanical fastener is a blind rivet.

9. The battery cell stack assembly of claim 5, wherein the angled portion of each arm of the at least one current collector bracket assembly is shaped to direct the arm from the proximate end positioned to either the anode cell tabs or the cathode cell tabs.

10. The battery cell stack assembly of claim 5, wherein the linear portion of each arm of the at least one current collector bracket assembly is in electrical contact with either the anode cell tabs or the cathode cell tabs.

11. The battery cell stack assembly of claim 1, wherein the anode electrode sheet is constructed at least in part by copper.

12. The battery cell stack assembly of claim 11, wherein the at least one current collector bracket assembly that electrically connects the anode cell tabs with one another is constructed at least in part of copper or a copper alloy.

13. The battery cell stack assembly of claim 1, wherein the cathode electrode sheet is constructed at least in part by aluminum.

14. The battery cell stack assembly of claim 13, wherein the at least one current collector bracket assembly that electrically connects the anode cell tabs with one another is constructed at least in part of aluminum or an aluminum alloy.

15. The battery cell stack assembly of claim 1, wherein up to about one hundred and twenty electrode cell tabs are joined to the at least one arm.

16. A method of assembling a plurality of cell stacks together to create a battery cell stack assembly, the method comprising:
aligning a plurality of anode cell tabs and a plurality of cathode cell tabs of a cell stack with one another, wherein the cell stack includes two or more monocells that each include an anode electrode sheet having an outer perimeter and an anode cell tab projecting outward from and extends past the outer perimeter of the anode electrode sheet and a cathode electrode sheet having an outer perimeter and a cathode cell tab projecting outward from and extends past the outer perimeter of the cathode electrode sheet;
electrically connecting the plurality of anode cell tabs with an arm that is part of one of two current collector bracket assemblies by a joining process and electrically connecting the plurality of cathode cell tabs with the arm of a remaining one of the two current collector bracket assemblies by the joining process, wherein each current collector bracket assembly includes a plurality of arms;
aligning an opening defined by a proximate end of each of the plurality of arms of a respective current collector bracket assembly with one another; and
securing the plurality of arms of each current collector bracket assembly to one another by a mechanical fastener received by the openings defined by the proximate end of each of the plurality of arms, wherein each arm of each current collector bracket is electrically connected to one of the plurality of cell stacks.

17. The method of claim 16, further comprising:
electrically connecting the plurality of anode cell tabs with the arm that is part of one of the two current collector bracket assemblies and electrically connecting the plurality of cathode cell tabs with the arm of the remaining one of the two current collector bracket assemblies by ultrasonic welding.

18. A battery cell stack assembly for a prismatic battery, the battery cell stack assembly comprising:
a plurality of monocells, wherein each monocell comprises:
an anode electrode sheet having an outer perimeter and an anode cell tab projecting outward from and extends past the outer perimeter of the anode electrode sheet and a cathode electrode sheet having an outer perimeter and a cathode cell tab projecting outward from and extends past the outer perimeter of the cathode electrode sheet, wherein each of the anode cell tabs of the battery cell stack assembly are aligned with one another and each of the cathode cell tabs are aligned with one other; and
two current collector bracket assemblies, wherein one of the current collector bracket assemblies electrically connect each of the anode cell tabs with one another and a remaining current collector bracket assembly electrically connects each of the cathode cell tabs with one another, and wherein each current collect bracket assembly includes a plurality of arms that are each positioned to electrically connect either two or more of the anode cell tabs or two or more of the cathode cell tabs to one another, and wherein each arm of the plurality of arms of each current collector bracket assembly defines a proximate end, a distal end, an angled portion, and a linear portion.

19. The battery cell stack assembly of claim 18, wherein the proximate end of each arm of the current collector bracket assembly defines an opening, and wherein the proximate end of each of the plurality of arms of the current collector bracket assembly are stacked one on top of another to align the respective openings of each of the plurality of arms with one another.

20. The battery cell stack assembly of claim 19, wherein a mechanical fastener is received by each of the openings of the plurality of arms.
